(19) United States
(12) Patent Application Publication
(10) Pub. No.: US 2024/0394042 A1
(43) Pub. Date: Nov. 28, 2024

(54) INDEPENDENTLY UPGRADEABLE DOCKING STATIONS

(71) Applicant: Targus International LLC, Anaheim, CA (US)

(72) Inventors: Man Cheung Dan Tsang, Anaheim, CA (US); Chi Hang Leung, Hong Kong (CN); Ronald DeCamp, Anaheim, CA (US)

(21) Appl. No.: 18/792,447

(22) Filed: Aug. 1, 2024

Related U.S. Application Data
(63) Continuation of application No. 17/447,669, filed on Sep. 14, 2021, now Pat. No. 12,073,205.

(51) Int. Cl. G06F 8/654; G06F 1/16; G06F 13/42; H04L 9/32

(52) U.S. Cl. CPC G06F 8/654; G06F 13/4282; H04L 9/3247; G06F 1/1632; G06F 2213/0042

(57) ABSTRACT

Systems and methods for independently upgradeable docking stations are discussed herein. One or more chipsets of a docking station may provide services to a host device, and each may use a corresponding firmware. The docking station may receive chipset firmware update data for one or more of the chipsets. In a first case, this data is received from a universal serial bus (USB) storage device (which in some cases can independently update its copy of the chipset firmware update data with a cloud server). In other cases, this data is received from a cloud server using a network interface system on a chip (which may be internal to, or separately connected to, the docking station). The docking station performs this receipt and/or the corresponding firmware update with no input from any host device that may (or may not) be attached, and/or without interrupting chipset services of any such host device.

### RELATED APPLICATIONS

This application is a continuation of U.S. Non-Provisional application Ser. No. 17/447,669, filed Sep. 14, 2021, titled INDEPENDENTLY UPGRADEABLE DOCKING STATIONS, which is hereby incorporated by reference in its entirety.

### TECHNICAL FIELD

This application relates generally to docking stations, including docking stations that are independently upgradeable (e.g., can be upgraded without the use and/or presence of a host device attached to the docking station).

### BACKGROUND

Docking stations for electronic host devices may be configured to allow a host device connected to the docking station to operate with and/or use one or more external devices (also) connected the docking station. Examples of host devices may include a laptop, a tablet, a smartphone, etc. Examples of external devices may include a display monitor, a mouse, a keyboard, a network switch, a universal serial bus (USB) device, etc. Further, the docking station may provide power to the host device that the host device can use to operate (e.g., perform user functions, charge a battery, etc.).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a system including a universal serial bus (USB) storage device and a docking station, according to an embodiment.

FIG. 2 illustrates a system including a USB storage device, a docking station, a cloud server, and an Ethernet/Wi-Fi access point according to an embodiment.

FIG. 3 illustrates a system including a cloud server, an Ethernet/Wi-Fi access point, an external network interface system on a chip (SoC), and a docking station, according to an embodiment.

FIG. 4 illustrates a system including a cloud server, an Ethernet/Wi-Fi access point, and a docking station, according to an embodiment.

FIG. 5 illustrates a method of performing a docking station chipset firmware update, according to an embodiment.

FIG. 6 illustrates a method of a USB storage device, according to an embodiment.

### DETAILED DESCRIPTION

Docking stations may include one or more chipsets that operate to interface the docking station with a host device using the docking station. One or more of the chipsets may be responsible for transporting data as between the host device and the docking station (in either direction), and/or for signaling for or otherwise controlling power distribution from the docking station to the host device. The chipsets may perform these operations relative to one or more ports on the docking station. For example, in the case of a host device that is connected to a universal serial bus (USB) Type C (USB-C) port on the docking station, a first chipset may be responsible for transporting video data through the USB-C port as between the host device and the docking station, a second chipset may be responsible for transporting power through the USB-C port from the docking station to the host device, and a third chipset may be responsible for transporting data from an external device attached to the docking station from the docking station to the host device through the USB-C port. It is also contemplated that multiple ports of the docking station may be so used between one (or more) host devices. The operation(s) of a chipset as between a host device and the docking station may be referred to herein as “chipset services.” It is contemplated that a docking station may comprise any combination of such chipset(s) that are configured to provide any corresponding combination of chipset service(s).

The chipsets of the docking station may operate their services according to a firmware for the chipset. The firmware may be stored on a memory of the chipset (or another memory found on the docking station that corresponds to the associated chipset), and may, when used to configure the chipset, enable the chipset to perform its associated services. In some instances, a firmware for a chipset of the docking station may be updated (or upgraded). Such updates may improve the operation of the chipset (e.g., make the chipset more efficient and/or accurate in performing its associated service(s) for host device(s), enable the chipset to perform new services for host device(s), and/or enable the chipset to operate with a new kind of host device, etc.).

In some cases, docking station chipset firmware updates may be performed while a host device is attached to the docking station. This may be because in some instances a host device is used to perform the firmware update by leveraging communications between the host device and the docking station. However, a system for docking station chipset firmware updates that uses a host device to update the chipset(s) of the docking station may cause the interruption of valuable worktime corresponding to the docking station, as, for example, a host device capable of updating the docking station chipset(s) must occupy the docking station to perform the update. Systems depending on host devices to perform docking station chipset firmware updates may also incur logistics concerns, in that the scheduling of updates at the right time for various groups in different locations (and any placement of human operators to perform the updates) may be difficult and/or time-consuming, and may need to be done outside the regular workday to avoid interruption.

Further, systems depending on host devices to perform docking station chipset firmware updates may depend on specific types of host devices. For example, if the chipset firmware update software for a docking station is Microsoft™ Windows™ based, the logistics of providing a Windows™ based host device at the docking station in order to perform the update may not be convenient (e.g., for companies that regularly equip their users with non-Windows™ based computers). Finally, systems depending on host devices to perform docking station chipset firmware updates may (in cases undesirably) allow chipset firmware to be changed via a host device with no (or insufficient) security protections.

It may therefore be beneficial to develop systems and methods of a docking station chipset firmware updating solution that does not require the use of a host device. Such methods may enable the updating of one or more chipsets of a docking station without the productivity, logistical, compatibility, and/or security concerns discussed above (among other possible issues).

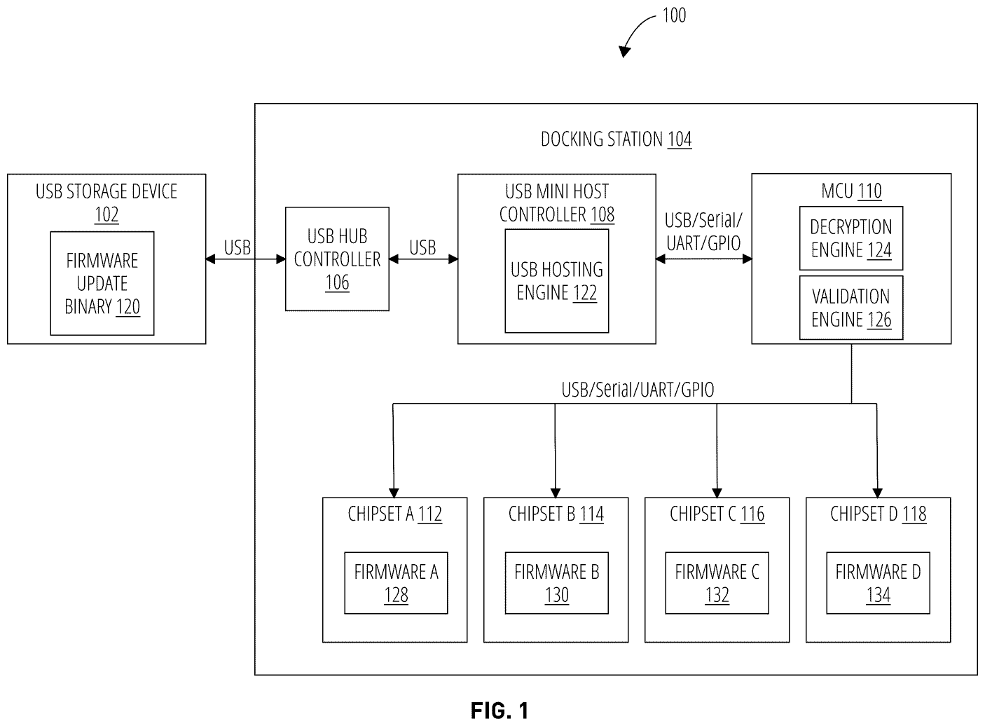

FIG. 1 illustrates a system 100 including a USB storage device 102 and a docking station 104, according to an embodiment. As illustrated, the USB storage device 102 may include a firmware update binary 120. The docking station 104 may include a USB hub controller 106, a USB mini host controller 108 having a USB hosting engine 122, a microcontroller unit (MCU) 110 having a decryption engine 124 and a validation engine 126, and a number of chipsets, each operating according to its respective firmware. In the example of FIG. 1, the docking station 104 comprises a chipset A 112 having firmware A 128, a chipset B 114 having firmware B 130, a chipset C 116 having firmware C 132, and a chipset D 118 having firmware D 134.

The USB storage device 102 may contain chipset firmware update data useable to perform a firmware update for one or more chipsets of the docking station 104. For example, the USB storage device 102 may contain a firmware update binary 120 that can be used by the docking station 104 to update one or more of the chipsets 112 through 118. The USB storage device 102 may be any type of storage device capable of communicating over USB, such as, for example, a flash drive, a hard drive, a solid state drive, etc.

It is contemplated that in some embodiments, the firmware update binary 120 is encrypted to protect the contents of the firmware update binary 120. Further, it is contemplated that in some embodiments, the firmware update binary 120 may be signed such that the integrity of the firmware update binary 120 can be verified by the docking station 104.

As illustrated, the USB storage device 102 communicates with the USB hub controller 106 of the docking station 104 via a USB interface. For example, each of the USB storage device 102 and the docking station 104 may include respective USB ports corresponding to the USB interface (e.g., a USB-A port, a USB-C port, etc.) that can be used to physically connect the USB storage device 102 to the USB hub controller 106 of the docking station 104. This USB interface may be an example of a physical communication interface used by the docking station 104.

The USB hub controller 106 may be responsible for managing signaling that occurs according to this physical connection. The USB hub controller 106 communicates (via a second USB interface, as illustrated) with a USB mini host controller 108 of the docking station 104. The USB mini host controller 108 may include a USB hosting engine 122 that, when operated by the USB mini host controller 108, can host the USB storage device 102 for the docking station 104 (via the USB hub controller 106). In other words, the USB hosting engine 122 includes instructions that, when operated by the USB mini host controller 108 of the docking station 104, configure the docking station 104 to read and/or write data to and/or from the USB storage device 102. This may occur independently of any host device that is (or is not) also connected to the docking station 104.

Then, through the operation of the USB hosting engine 122, the USB hub controller 106 receives the firmware update binary 120 from the USB storage device 102 (e.g., via a USB connection to the USB storage device 102) and then passes the firmware update binary 120 to the USB mini host controller 108 (e.g., via the second USB interface, as illustrated).

As shown in FIG. 1, the USB mini host controller 108 may be in communication with the MCU 110 via one of a (third) USB interface, a serial interface, a universal asynchronous receiver-transmitter (UART) interface, or a general purpose input/output (GPIO) interface that may exist between the USB mini host controller 108 and the MCU 110. The USB mini host controller 108 may pass the firmware update binary 120 to the MCU 110 according to an interface used between the two.

Upon receipt of the firmware update binary 120, the MCU 110 may determine whether the firmware update binary 120 is encrypted. If so, the decryption engine 124 of the MCU 110 is used to decrypt the firmware update binary 120 as received. In some embodiments, if the firmware update binary 120 cannot be decrypted, the firmware update binary 120 is not further used and is discarded. This decryption may be performed without any input from any host device attached to the docking station 104 (which may or may not be present)

Further, the MCU 110 may determine whether the firmware update binary 120 is signed. If so, the validation engine 126 of the MCU 110 may be used to validate the signature of the firmware update binary 120 as received, thereby ensuring that the firmware update binary 120 is valid. In some embodiments, if the firmware update binary 120 is not signed, or if the signature is determined to be invalid, the firmware update binary 120 is not further used and is instead discarded. This validation may be performed without any input from any host device attached to the docking station 104 (which may or may not be present).

Once the firmware update binary 120 is decrypted and/or validated, the MCU 110 may proceed to perform a firmware update for one or more of the chipset A 112, the chipset B 114, the chipset C 116, and/or the chipset D 118 using the firmware update binary 120. This process may change or replace the firmware of the respective chipset. For example, it may be that the firmware update binary 120 is operable to change or replace the firmware A 128 of chipset A 112. In other cases, it may be that the firmware update binary 120 is operable to change or replace each of the firmware A 128 of chipset A 112 and the firmware C 132 of chipset C 116. In other cases, it may be that the firmware update binary 120 is operable to change or replace the firmware of all chipsets of the docking station 104 (e.g., change or replace the firmware A 128 of the chipset A 112, the firmware B 130 of the chipset B 114, the firmware C 132 of the chipset C 116, and the firmware D 134 of the chipset D 118).

As illustrated, the MCU 110 may communicate with the chipsets 112 through 118 via one or more of a USB interface, a serial interface, a UART interface, or a GPIO interface. In some embodiments, different interfaces could be used for different chipsets (e.g., the MCU 110 could communicate with the chipset A 112 via a serial interface, while the MCU 110 communicates with the chipset D 118 via a GPIO interface). According to the operability of the firmware update binary 120, the firmware update is performed for a respective chipset via the interface between the chipset and the MCU 110.

The firmware update process for the one or more chipsets 112 through 118 can be performed without any input from any host device of the docking station 104. For example, the USB mini host controller 108 may operate the USB hosting engine 122 to access the firmware update binary 120 on the USB storage device 102 and eventually communicate the firmware update binary 120 to the MCU 110 independently of any host device useable with the docking station 104. Further, the MCU 110 may then perform a corresponding firmware update for any of the chipsets 112 through 118 independently of any host device useable with the docking station 104. In other words, the firmware update process described in relation to the system 100 can happen independently of whether or not any host device is connected to the docking station 104 at the time of the firmware update.

Further, it is anticipated that the firmware update process described above could be performed while the docking station 104 (also) continues to perform the functions of the docking station 104 for an attached host device (in the case that one is attached to the docking station 104 at the time of the firmware update). For example, the USB storage device 102 could be inserted into the docking station 104, and the MCU 110 may receive the firmware update binary 120 from the USB storage device 102 and use it to perform a corresponding firmware update, while the docking station 104 continues to, for example, transport data between the host device and the docking station 104 and/or transport power from the docking station 104 to the host device.

It is contemplated that in alternative embodiments to FIG. 1, an MCU of the docking station 104 having the functions of the MCU 110 may itself (also) include a USB mini host controller and/or a USB hub controller. In such cases, the USB interface illustrated in FIG. 1 between the USB hub controller 106 and the USB mini host controller 108 may not be used, and/or the one or more of the USB, serial, UART, and/or GPIO interface(s) illustrated between the USB mini host controller 108 and the MCU 110 in FIG. 1 may not be used. Further, in cases where the functions of a USB hub controller and a USB mini host controller are incorporated into such an MCU, a USB port to which a USB storage device is connected may correspond to a USB interface proceeding directly to that MCU (with the supporting operations of the USB hosting engine in such cases being performed directly by that MCU).

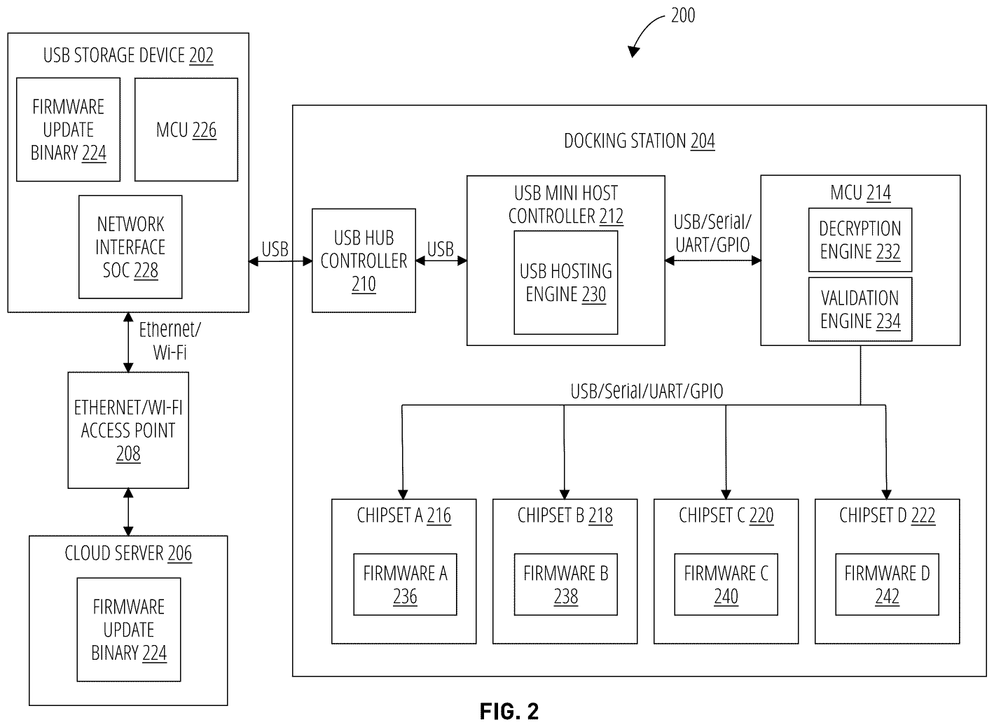

FIG. 2 illustrates a system 200 including a USB storage device 202, a docking station 204, a cloud server 206, and an Ethernet/Wi-Fi access point 208 according to an embodiment. As illustrated, the USB storage device 202 may include a firmware update binary 224, an MCU 226, and a network interface system on a chip (SoC) 228. The docking station 204 may include a USB hub controller 210, a USB mini host controller 212 having a USB hosting engine 230, an MCU 214 having a decryption engine 232 and a validation engine 234, and a number of chipsets, each operating according to its respective firmware. In the example of FIG. 2, the docking station 204 comprises a chipset A 216 having firmware A 236, a chipset B 218 having firmware B 238, a chipset C 220 having firmware C 240, and a chipset D 222 having firmware D 242. The cloud server 206 may include the firmware update binary 224 (which may be the same firmware update binary 224 as that found on the USB storage device 202).

The cloud server 206 may host a pre.-determined and/or generally accessible network location (e.g., on the Internet) where chipset firmware update data useable to perform a firmware update for one or more chipsets of the docking station 204 may be found. The firmware update binary 224 may be an example of such chipset firmware update data. The firmware update binary 224 (as found on the cloud server 206) may be kept up-to-date by, e.g., a manufacturer or provider of the other elements of the system 200 (e.g., a manufacturer/provider of either or both of the USB storage device 202 and/or the docking station 204). Accordingly, it may be understood in some cases that the firmware update binary 224 as found on the cloud server 206 is an up-to-date or “production” firmware update binary 224 for updating one or more chipsets of the docking station 204.

The cloud server 206 may send the firmware update binary 224 to the Ethernet/Wi-Fi access point 208 (e.g., via the Internet). The Ethernet/Wi-Fi access point 208 may be an access point that is local to the USB storage device 202. For example, it may be an access point that is within a Wi-Fi communication range with the general location of the USB storage device 202, or an access point physically situated relatively near to the USB storage device 202 such that a physical connection (e.g., an Ethernet cable) can feasibly be run between the Ethernet/Wi-Fi access point 208 and the general location of the USB storage device 202.

The network interface SoC 228 of the USB storage device 202 may include any connectors, circuitry, and firmware for receiving network communications (e.g., a “network interface”) from an access point external to the docking station USB storage device 202 (such as the Ethernet/Wi-Fi access point 208). For example, the network interface SoC 228 may include one or more antenna(s) and related circuitry and firmware for a Wi-Fi interface between the network interface SoC 228 and the Ethernet/Wi-Fi access point 208. Additionally or alternatively, the network interface SoC 228 may include an RJ-45 port and related circuitry and firmware for an Ethernet interface (facilitated by an Ethernet cable) between the network interface SoC 228 and the Ethernet/Wi-Fi access point 208.

Under instructions from the MCU 226, the USB storage device 202 may use the network interface SoC 228 to communicate with the cloud server 206 via the Ethernet/Wi-Fi access point 208. As part of this communication, the USB storage device 202 may be able to receive or download the firmware update binary 224 from the cloud server 206 (accordingly, it may be understood that each of the cloud server 206 and the USB storage device 202 has a copy of the same firmware update binary 224, as illustrated). The MCU 226 may be configured to cause this behavior by the USB storage device 202 as part of ensuring that a firmware update binary as stored at the USB storage device 202 matches the firmware update binary 224 as stored on the cloud server 206 (e.g., so that it can update or replace the firmware update binary as stored at the USB storage device 202 to match the firmware update binary 224 as stored on the cloud server 206). Accordingly, whenever this behavior occurs, because the firmware update binary 224 on the cloud server 206 is kept up-to-date as described above, the corresponding firmware update binary 224 on the USB storage device 202 is also (as a result of this behavior) kept up-to-date.

The MCU may perform a check with the cloud server (via the Ethernet/Wi-Fi access point 208) whether the USB storage device 202 has a firmware update binary that matches a firmware update binary found on the cloud server 206. As a first example of such a check, there may be cases where the MCU determines that a USB storage device 202 device does not yet have a firmware update binary (e.g., the firmware update binary 224, as illustrated in FIG. 2, or any other firmware update binary, may not yet be present on the USB storage device 202). In such cases, the MCU triggers the above-described download behavior to cause the USB storage device 202 to obtain the firmware update binary 224 from the cloud server 206.

In a second example of such a check involving cases where the USB storage device 202 already has a firmware update binary, the MCU 226 may communicate with the cloud server 206 to check whether the firmware update binary 224 on the cloud server 206 matches the firmware update binary that is stored on the USB storage device 202, and, if not, it causes the USB storage device 202 to perform the above-described download behavior to obtain the firmware update binary 224 from the cloud server. The firmware update binary stored on the USB storage device 202 is then matched to and/or replaced with the firmware update binary 224).

Such checks check may be performed by the MCU 226 of the USB storage device 202, for example, on a configured (e.g., periodic) basis, whenever the USB storage device 202 connects to an Ethernet/Wi-Fi access point (such as the Ethernet/Wi-Fi access point 208) via a network interface (such as the network interface SoC 228), and/or whenever the USB storage device 202 connects to a docking station 204 and prior to providing the firmware update binary 224 to the docking station 204 (as will be described).

Then, the firmware update binary 224 (e.g., the up-to-date copy present on the USB storage device 202) can be used by the docking station 204 to update one or more of the chipsets 216 through 222. The USB storage device 202 may be any type of storage device capable of communicating over USB, such as, for example, a flash drive, a hard drive, a solid state drive, etc.

It is contemplated that in some embodiments, the firmware update binary 224 is encrypted to protect the contents of the firmware update binary 224. Further, it is contemplated that in some embodiments, the firmware update binary 224 may be signed such that the integrity of the firmware update binary 224 can be verified by the docking station 204.

As illustrated, the USB storage device 202 communicates with the USB hub controller 210 of the docking station 204 via a USB interface. For example, each of the USB storage device 202 and the docking station 204 may include respective USB ports corresponding to the USB interface (e.g., a USB-A port, a USB-C port, etc.) that can be used to physically connect the USB storage device 202 to the USB hub controller 210 of the docking station 204. This USB interface may be an example of a physical communication interface used by the docking station 204.

The USB hub controller 210 may be responsible for managing signaling that occurs according to this physical connection. The USB hub controller 210 communicates (via a second USB interface, as illustrated) with a USB mini host controller 212 of the docking station 204. The USB mini host controller 212 may include a USB hosting engine 230 that, when operated by the USB mini host controller 212, can host the USB storage device 202 for the docking station 204 (via the USB hub controller 210). In other words, the USB hosting engine 230 includes instructions that, when operated by the USB mini host controller 212 of the docking station 204, configure the docking station 204 to read and/or write data to and/or from the USB storage device 202. This may occur independently of any host device that is (or is not) also connected to the docking station 204.

Then, through the operation of the USB hosting engine 230, the USB hub controller 210 receives the firmware update binary 224 from the USB storage device 202 (e.g., via a USB connection to the USB storage device 202) and then passes the firmware update binary 224 to the USB mini host controller 212 (e.g., via the second USB interface, as illustrated).

As shown in FIG. 2, the USB mini host controller 212 may be in communication with the MCU 214 via one of a (third) USB interface, a serial interface, a universal asynchronous receiver-transmitter (UART) interface, or a general purpose input/output (GPIO) interface that may exist between the USB mini host controller 212 and the MCU 214. The USB mini host controller 212 may pass the firmware update binary 224 to the MCU 214 according to an interface used between the two.

Upon receipt of the firmware update binary 224, the MCU 214 may determine whether the firmware update binary 224 is encrypted. If so, the decryption engine 232 of the MCU 214 is used to decrypt the firmware update binary 224 as received. In some embodiments, if the firmware update binary 224 cannot be decrypted, the firmware update binary 224 is not further used and is discarded. This decryption may be performed without any input from any host device attached to the docking station 204 (which may or may not be present)

Further, the MCU 214 may determine whether the firmware update binary 224 is signed. If so, the validation engine 234 of the MCU 214 may be used to validate the signature of the firmware update binary 224 as received, thereby ensuring that the firmware update binary 224 is valid. In some embodiments, if the firmware update binary 224 is not signed, or if the signature is determined to be invalid, the firmware update binary 224 is not further used and is instead discarded. This validation may be performed without any input from any host device attached to the docking station 204 (which may or may not be present).

Once the firmware update binary 224 is decrypted and/or validated, the MCU 214 may proceed to perform a firmware update for one or more of the chipset A 216, the chipset B 218, the chipset C 220, and/or the chipset D 222 using the firmware update binary 224. This process may change or replace the firmware of the respective chipset. For example, it may be that the firmware update binary 224 is operable to change or replace the firmware A 236 of chipset A 216. In other cases, it may be that the firmware update binary 224 is operable to change or replace each of the firmware A 236 of chipset A 216 and the firmware C 240 of chipset C 220. In other cases, it may be that the firmware update binary 224 is operable to change or replace the firmware of all chipsets of the docking station 204 (e.g., change or replace the firmware A 236 of the chipset A 216, the firmware B 238 of the chipset B 218, the firmware C 240 of the chipset C 220, and the firmware D 242 of the chipset D 222).

As illustrated, the MCU 214 may communicate with the chipsets 216 through 222 via one or more of a USB interface, a serial interface, a UART interface, or a GPIO interface. In some embodiments, different interfaces could be used for different chipsets (e.g., the MCU 214 could communicate with the chipset A 216 via a serial interface, while the MCU 214 communicates with the chipset D 222 via a GPIO interface). According to the operability of the firmware update binary 224, the firmware update is performed for a respective chipset via the interface between the chipset and the MCU 214.

The firmware update process for the one or more chipsets 216 through 222 can be performed without any input from any host device of the docking station 204. For example, the USB mini host controller 212 may operate the USB hosting engine 230 to access the firmware update binary 224 on the USB storage device 202 and eventually communicate the firmware update binary 224 to the MCU 214 independently of any host device useable with the docking station 204. Further, the MCU 214 may then perform a corresponding firmware update for any of the chipsets 216 through 222 independently of any host device useable with the docking station 204. In other words, the firmware update process described in relation to the system 200 can happen independently of whether or not any host device is connected to the docking station 204 at the time of the firmware update.

Further, it is anticipated that the firmware update process described above could be performed while the docking station 204 (also) continues to perform the functions of the docking station 204 for an attached host device (in the case that one is attached to the docking station 204 at the time of the firmware update). For example, the USB storage device 202 could be inserted into the docking station 204, and the MCU 214 may receive the firmware update binary 224 from the USB storage device 202 and use it to perform a corresponding firmware update, while the docking station 204 continues to, for example, transport data between the host device and the docking station 204 and/or transport power from the docking station 204 to the host device.

It is contemplated that in alternative embodiments to FIG. 2, an MCU of the docking station 204 having the functions of the MCU 214 may itself (also) include a USB mini host controller and/or a USB hub controller. In such cases, the USB interface illustrated in FIG. 2 between the USB hub controller 210 and the USB mini host controller 212 may not be used, and/or the one or more of the USB, serial, UART, and/or GPIO interface(s) illustrated between the USB mini host controller 212 and the MCU 214 in FIG. 2 may not be used. Further, in cases where the functions of a USB hub controller and a USB mini host controller are incorporated into such an MCU, a USB port to which a USB storage device is connected may correspond to a USB interface proceeding directly to that MCU (with the supporting operations of the USB hosting engine in such cases being performed directly by that MCU).

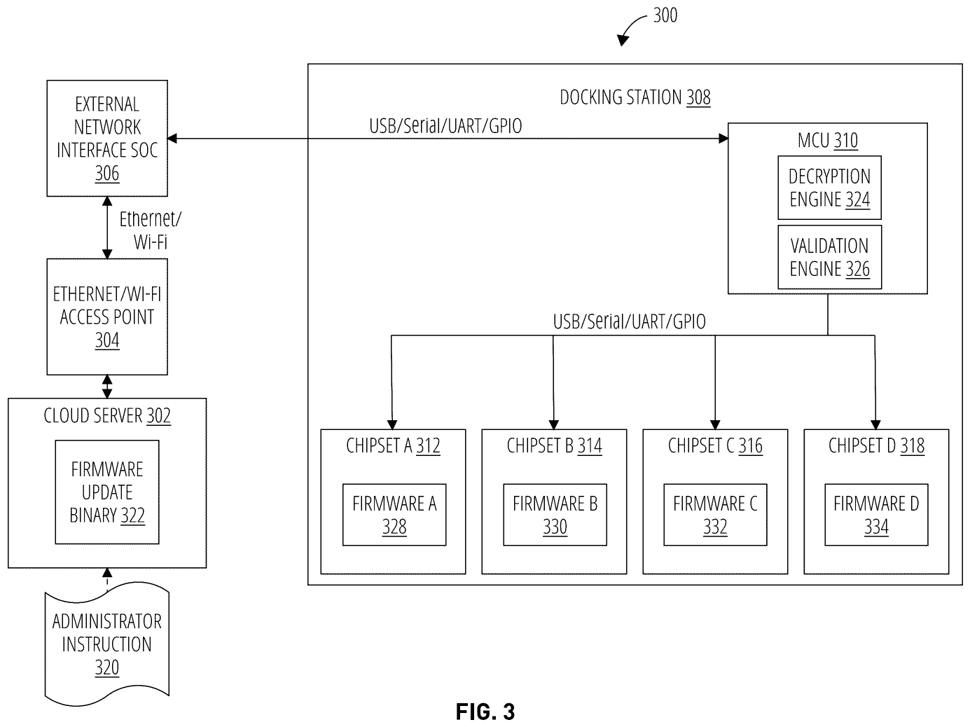

FIG. 3 illustrates a system 300 including a cloud server 302, an Ethernet/Wi-Fi access point 304, an external network interface SoC 306, and a docking station 308, according to an embodiment. As illustrated, the cloud server 302 may include a firmware update binary 322. The docking station 308 may include an MCU 310 having a decryption engine 324 and a validation engine 326 and a number of chipsets, each operating according to its respective firmware. In the example of FIG. 3, the system 300 comprises a chipset A 312 having firmware A 328, a chipset B 314 having firmware B 330, a chipset C 316 having firmware C 332, and a chipset D 318 having firmware D 334.

As illustrated, an administrator instruction 320 may arrive at the cloud server 302. Alternatively, the administrator instruction 320 may originate at the cloud server 302. The administrator instruction 320 may instruct the cloud server 302 to perform a firmware update for one or more of the chipsets 312 to 318 of the docking station 308.

The cloud server 302 may be, for example, a system operated by an administrator of the system 300 and that can be reached via a network (e.g., the Internet). The cloud server 302 may contain chipset firmware update data useable to perform a firmware update for one or more of the chipsets of the docking station 308. For example, the cloud server 302 may contain a firmware update binary 322 that can be used by the docking station 308 to update the firmware of one or more of the chipsets 312 through 318.

The administrator instruction 320 may arrive/occur at the cloud server 302 according to a configuration of the cloud server 302 (e.g., as configured by an administrator of the system 300). For example, the administrator instruction 320 may arrive/occur whenever it is determined by the cloud server 302 that new firmware for one or more of the chipsets 312 through 318 of the docking station 308 is available, and/or at a predetermined update cadence. Alternatively, the administrator instruction 320 may be manually triggered (e.g., via manual interaction with a user of the cloud server 302).

In response to the administrator instruction 320, the cloud server 302 may send the firmware update binary 322 to the Ethernet/Wi-Fi access point 304 (e.g., via the Internet). The Ethernet/Wi-Fi access point 304 may be an access point that is local to the docking station 308. For example, it may be an access point that is within a Wi-Fi communication range with the general location of the docking station 308, or an access point physically situated relatively near to the docking station 308 such that a physical connection (e.g., an Ethernet cable) can feasibly be run between the Ethernet/Wi-Fi access point 304 and the general location of the docking station 308.

As illustrated, the docking station 308 may be connected to an external network interface SoC 306. The external network interface SoC 306 may communicate with the MCU 310 of the docking station 308 via one or more of a USB interface (e.g., via USB ports of the external network interface SoC 306 and the docking station 308), a serial interface (e.g., via serial ports of the external network interface SoC 306 and the docking station 308), a UART interface (e.g., via an RS232 (DB9) connector on each of the external network interface SoC 306 and the docking station 308), and/or a GPIO interface (e.g., via GPIO pins of the external network interface SoC 306 and the docking station 308), each of which may be an example of a physical communication interface used by the docking station 308. The external network interface SoC 306 may also include any connectors, circuitry, and firmware for receiving network communications (e.g., a “network interface”) from an access point external to the docking station 308 (such as the Ethernet/Wi-Fi access point 304). For example, the external network interface SoC 306 may include one or more antenna(s) and related circuitry and firmware for a Wi-Fi interface between the external network interface SoC 306 and the Ethernet/Wi-Fi access point 304. Additionally or alternatively, the external network interface SoC 306 may include an RJ-45 port and related circuitry and firmware for an Ethernet interface (facilitated by an Ethernet cable) between the external network interface SoC 306 and the Ethernet/Wi-Fi access point 304.

The external network interface SoC 306 may have been connected to the docking station 308 for purposes of facilitating a firmware update of one or more of the chipsets 312 to 318 and may therefore be in proximity to the docking station 308 (and thus within the described range of the Ethernet/Wi-Fi access point 304). Accordingly, the Ethernet/Wi-Fi access point 304 may provide the firmware update binary 322 to the external network interface SoC 306 via one or more of the Ethernet and/or Wi-Fi interface. The external network interface SoC 306 may then use one or more of the in-use USB, serial, UART, and/or GPIO interface(s) between the external network interface SoC 306 and the MCU 310 of the docking station 308 to provide the MCU 310 with the firmware update binary 322.

Upon receipt of the firmware update binary 322, the MCU 310 may determine whether the firmware update binary 322 is encrypted. If so, the decryption engine 324 of the MCU 310 is used to decrypt the firmware update binary 322 as received. In some embodiments, if the firmware update binary 322 cannot be decrypted, the firmware update binary 322 is not further used and is discarded. This decryption may be performed without any input from any host device attached to the docking station 308 (which may or may not be present)

Further, the MCU 310 may determine whether the firmware update binary 322 is signed. If so, the validation engine 326 of the MCU 310 may be used to validate the signature of the firmware update binary 322 as received, thereby ensuring that the firmware update binary 322 is valid. In some embodiments, if the firmware update binary 322 is not signed, or if the signature is determined to be invalid, the firmware update binary 322 is not further used and is instead discarded. This validation may be performed without any input from any host device attached to the docking station 308 (which may or may not be present).

Once the firmware update binary 322 is decrypted and/or validated, the MCU 310 may proceed to perform a firmware update for one or more of the chipset A 312, the chipset B 314, the chipset C 316, and/or the chipset D 318 using the firmware update binary 322. This process may change or replace the firmware of the respective chipset. For example, it may be that the firmware update binary 322 is operable to change or replace the firmware A 328 of chipset A 312. In other cases, it may be that the firmware update binary 322 is operable to change or replace each of the firmware A 328 of chipset A 312 and the firmware C 332 of chipset C 316. In other cases, it may be that the firmware update binary 322 is operable to change or replace the firmware of all chipsets of the docking station 308 (e.g., change or replace the firmware A 328 of the chipset A 312, the firmware B 330 of the chipset B 314, the firmware C 332 of the chipset C 316, and the firmware D 334 of the chipset D 318).

As illustrated, the MCU 310 may communicate with the chipsets 312 through 318 via one or more of a USB interface, a serial interface, a UART interface, or a GPIO interface. In some embodiments, different interfaces could be used for different chipsets (e.g., the MCU 310 could communicate with the chipset A 312 via a serial interface, while the MCU 310 communicates with the chipset D 318 via a GPIO interface). According to the operability of the firmware update binary 322, the firmware update is performed for a respective chipset via the interface between the chipset and the MCU 310.

The firmware update process for the one or more chipsets 312 through 318 can be performed without any input from any host device of the docking station 308. For example, the external network interface SoC 306 may receive the firmware update binary 322 from the Ethernet/Wi-Fi access point 304 and communicate the firmware update binary 322 to the MCU 310 independently of any host device useable with the docking station 308. Further, the MCU 310 may then perform a corresponding firmware update for any of the chipsets 312 through 318 independently of any host device useable with the docking station 308. In other words, the firmware update process described in relation to the system 300 can happen independently of whether or not any host device is connected to the docking station 308 at the time of the firmware update.

Further, it is anticipated that the firmware update process described above could be performed while the docking station 308 (also) continues to perform the functions of the docking station 308 for an attached host device (in the case that one is attached to the docking station 308 at the time of the firmware update). For example, the external network interface SoC 306 could be connected to the docking station 308 and receive the firmware update binary 322 from the Ethernet/Wi-Fi access point 304, and the MCU 310 may receive the firmware update binary 322 from the external network interface SoC 306 and use it to perform a corresponding firmware update, while the docking station 308 continues to, for example, transport data between the host device and the docking station 308 and/or transport power from the docking station 308 to the host device.

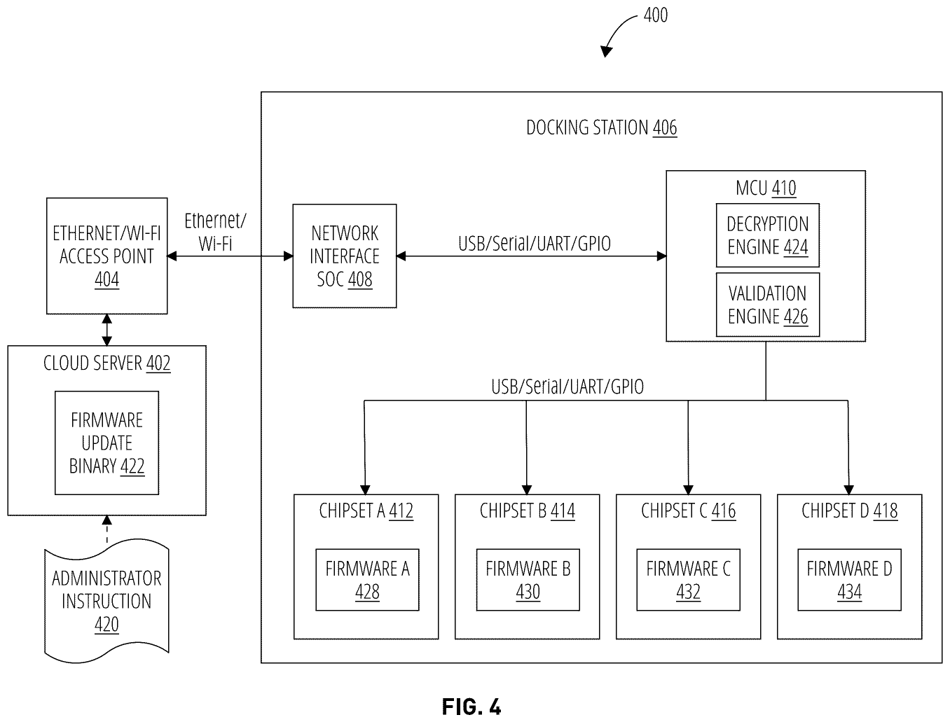

FIG. 4 illustrates a system 400 including a cloud server 402, an Ethernet/Wi-Fi access point 404, and a docking station 406, according to an embodiment. As illustrated, the cloud server 402 may include a firmware update binary 422. The docking station 406 may include a network interface SoC 408, an MCU 410 having a decryption engine 424 and a validation engine 426, and a number of chipsets, each operating according to its respective firmware. In the example of FIG. 4, the docking station 406 comprises a chipset A 412 having firmware A 428, a chipset B 414 having firmware B 430, a chipset C 416 having firmware C 432, and a chipset D 418 having firmware D 434.

As illustrated, an administrator instruction 420 may arrive at the cloud server 402. Alternatively, the administrator instruction 420 may originate at the cloud server 402. The administrator instruction 420 may instruct the cloud server 402 to perform a firmware update for one or more of the chipsets 412 to 418 of the docking station 406.

The cloud server 402 may be, for example, a system operated by an administrator of the system 400 and that can be reached via a network (e.g., the Internet). The cloud server 402 may contain chipset firmware update data useable to perform a firmware update for one or more of the chipsets of the docking station 406. For example, the cloud server 402 may contain a firmware update binary 422 that can be used by the docking station 406 to update the firmware of one or more of the chipsets 412 through 418.

The administrator instruction 420 may arrive/occur at the cloud server 402 according to a configuration of the cloud server 402 (e.g., as configured by an administrator of the system 400). For example, the administrator instruction 420 may arrive/occur whenever it is determined by the cloud server 402 that new firmware for one or more of the chipsets 412 through 418 of the docking station 406 is available, and/or at a predetermined update cadence. Alternatively, the administrator instruction 420 may be manually triggered (e.g., via manual interaction with a user of the cloud server 402).

In response to the administrator instruction 420, the cloud server 402 may send the firmware update binary 422 to the Ethernet/Wi-Fi access point 404 (e.g., via the Internet). The Ethernet/Wi-Fi access point 404 may be an access point that is local to the docking station 406. For example, it may be an access point that is within a Wi-Fi communication range with the general location of the docking station 406, or an access point physically situated relatively near to the docking station 406 such that a physical connection (e.g., an Ethernet cable) can feasibly be run between the Ethernet/Wi-Fi access point 404 and the general location of the docking station 406.

As illustrated, the docking station 406 may include a network interface SoC 408. The network interface SoC 408 may communicate with the MCU 410 of the docking station 406 via one or more of a USB interface, a serial interface, a UART interface, and/or a GPIO interface. The network interface SoC 408 may also include any connectors, circuitry, and firmware for receiving network communications (e.g., a “network interface”) from an access point external to the docking station 308 (such as the Ethernet/Wi-Fi access point 404). For example, the network interface SoC 408 may include one or more antenna(s) and related circuitry and firmware for a Wi-Fi interface between the network interface SoC 408 and the Ethernet/Wi-Fi access point 404. Such a Wi-Fi interface may be an example of a network interface of the docking station 406. Additionally or alternatively, the network interface SoC 408 may include an RJ-45 port (that is physically exposed through the docking station 406) and related circuitry and firmware for an Ethernet interface (facilitated by an Ethernet cable) between the network interface SoC 408 and the Ethernet/Wi-Fi access point 404. Such an Ethernet interface may be an example of each of a physical communication interface and a network interface of the docking station 406.

The Ethernet/Wi-Fi access point 404 may provide the firmware update binary 422 to the network interface SoC 408 via one or more of the Ethernet and/or Wi-Fi interface. The network interface SoC 408 may then use one or more of the in-use USB, serial, UART, and/or GPIO interface(s) between the network interface SoC 408 and the MCU 410 of the docking station 406 to provide the MCU 410 with the firmware update binary 422.

Upon receipt of the firmware update binary 422, the MCU 410 may determine whether the firmware update binary 422 is encrypted. If so, the decryption engine 424 of the MCU 410 is used to decrypt the firmware update binary 422 as received. In some embodiments, if the firmware update binary 422 cannot be decrypted, the firmware update binary 422 is not further used and is discarded. This decryption may be performed without any input from any host device attached to the docking station 406 (which may or may not be present)

Further, the MCU 410 may determine whether the firmware update binary 422 is signed. If so, the validation engine 426 of the MCU 410 may be used to validate the signature of the firmware update binary 422 as received, thereby ensuring that the firmware update binary 422 is valid. In some embodiments, if the firmware update binary 422 is not signed, or if the signature is determined to be invalid, the firmware update binary 422 is not further used and is instead discarded. This validation may be performed without any input from any host device attached to the docking station 406 (which may or may not be present).

Once the firmware update binary 422 is decrypted and/or validated, the MCU 410 may proceed to perform a firmware update for one or more of the chipset A 412, the chipset B 414, the chipset C 416, and/or the chipset D 418 using the firmware update binary 422. This process may change or replace the firmware of the respective chipset. For example, it may be that the firmware update binary 422 is operable to change or replace the firmware A 428 of chipset A 412. In other cases, it may be that the firmware update binary 422 is operable to change or replace each of the firmware A 428 of chipset A 412 and the firmware C 432 of chipset C 416. In other cases, it may be that the firmware update binary 422 is operable to change or replace the firmware of all chipsets of the docking station 406 (e.g., change or replace the firmware A 428 of the chipset A 412, the firmware B 430 of the chipset B 414, the firmware C 432 of the chipset C 416, and the firmware D 434 of the chipset D 418).

As illustrated, the MCU 410 may communicate with the chipsets 412 through 418 via one or more of a USB interface, a serial interface, a UART interface, or a GPIO interface. In some embodiments, different interfaces could be used for different chipsets (e.g., the MCU 410 could communicate with the chipset A 412 via a serial interface, while the MCU 410 communicates with the chipset D 418 via a GPIO interface). According to the operability of the firmware update binary 422, a firmware update is performed for a respective chipset via the interface between the chipset and the MCU 410.

The firmware update process for the one or more chipsets 412 through 418 can be performed without any input from any host device of the docking station 406. For example, the network interface SoC 408 may receive the firmware update binary 422 from the Ethernet/Wi-Fi access point 404 and communicate the firmware update binary 422 to the MCU 410 independently of any host device useable with the docking station 406. Further, the MCU 410 may then perform a corresponding firmware update for any of the chipsets 412 through 418 independently of any host device useable with the docking station 406. In other words, the firmware update process described in relation to the system 400 can happen independently of whether or not any host device is connected to the docking station 406 at the time of the firmware update.

Further, it is anticipated that the firmware update process described above could be performed while the docking station 406 (also) continues to perform the functions of the docking station 406 for an attached host device (in the case that one is attached to the docking station 406 at the time of the firmware update). For example, the network interface SoC 408 could receive the firmware update binary 422 from the Ethernet/Wi-Fi access point 404, and the MCU 310 may in turn receive the firmware update binary 422 from the network interface SoC 408 and use it to perform a corresponding firmware update, while the docking station 406 continues to, for example, transport data between the host device and the docking station 406 and/or transport power from the docking station 406 to the host device.

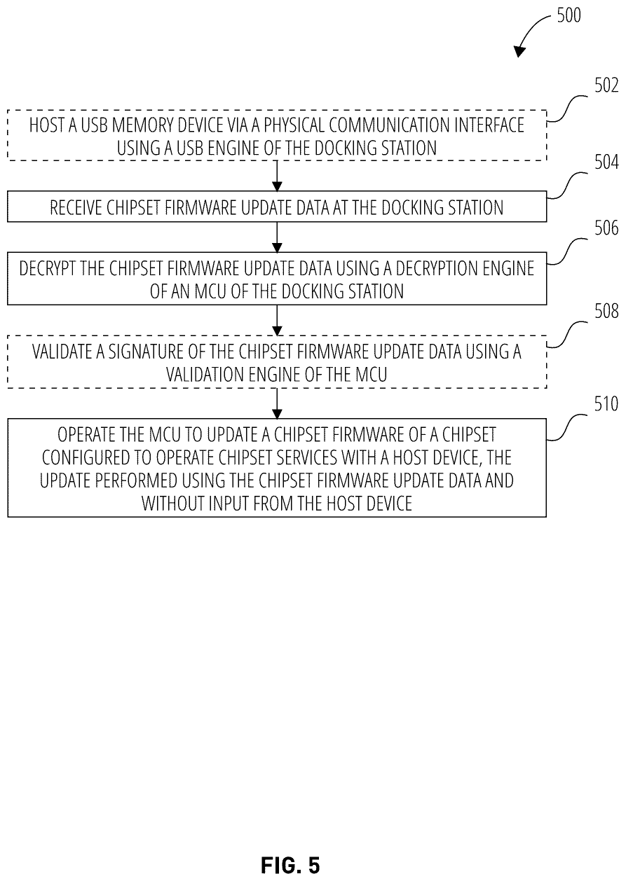

FIG. 5 illustrates a method 500 of performing a docking station chipset firmware update, according to an embodiment. The method 500 optionally includes hosting 502 a USB memory device via a physical communication interface using a USB engine of the docking station.

The method 500 further includes receiving 504 chipset firmware update data at the docking station. In some embodiments, the chipset firmware update data is received in encrypted form. Further, in some embodiments, the chipset firmware data is received in signed form (e.g., received along with a signature to use for validating the chipset firmware update data).

The method 500 further includes decrypting 506 the chipset firmware update data using a decryption engine of an MCU of the docking station.

The method 500 further optionally includes validating 508 the signature of the chipset firmware update data using a validation engine of the MCU.

The method 500 further includes operating 510 the MCU to update a chipset firmware of a chipset configured to operate chipset services with a host device, the update performed using the chipset firmware update data and without input from the host device.

In some embodiments of the method 500, the chipset firmware update data is received at the docking station via a physical communication interface of the docking station. In some of these embodiments that include the hosting 502, the chipset firmware update data is received at the docking station from the USB memory device via the physical communication interface being operated to host the USB memory device.

In some embodiments of the method 500, the chipset firmware update data is received at the docking station via a network interface of the docking station.

In some embodiments of the method 500, the chipset firmware update data is received at the docking station without input from the host device.

In some embodiments of the method 500, the chipset firmware update data is decrypted using the decryption engine of the MCU without input from the host device.

In some embodiments of the method 500 that include the validating 508, the signature of the chipset firmware update data is validated using the validation engine of the MCU without input from the host device.

In some embodiments of the method 500, the host device is not connected to the docking station.

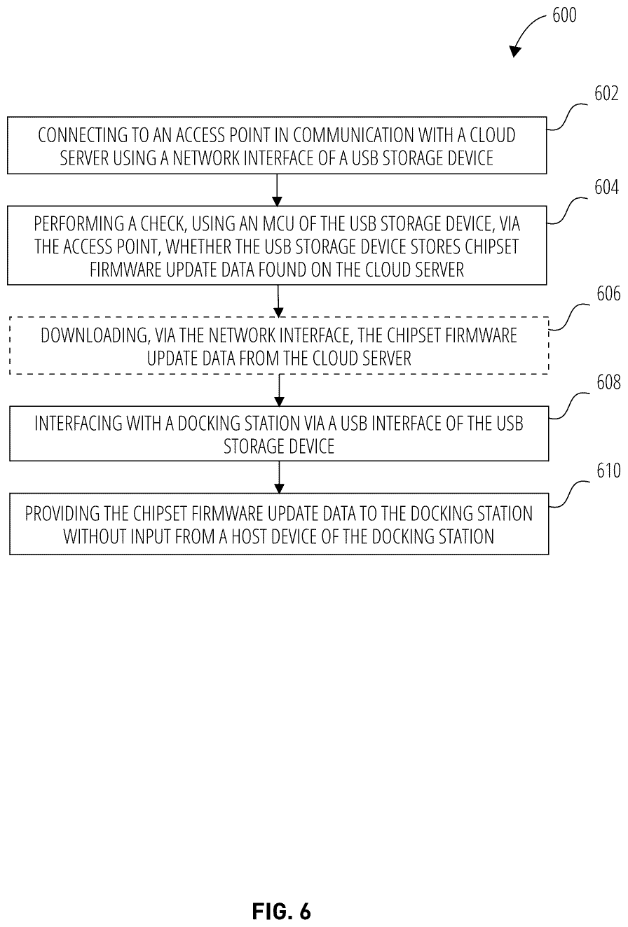

FIG. 6 illustrates a method 600 of a USB storage device, according to an embodiment. The method 600 includes connecting 602 to an access point in communication with a cloud server using a network interface of the USB storage device.

The method 600 further includes performing 604 a check, using an MCU of the USB storage device, via the access point, whether the USB storage device stores chipset firmware update data found on the cloud server.

The method 600 further optionally includes downloading 606, via the network interface, the chipset firmware update data from the cloud server. The downloading 606 may be performed responsive to a determination made by the MCU during the check that the USB storage device does not include the chipset firmware update data found on the cloud server.

The method 600 further includes interfacing 608 with a docking station via a USB interface of the USB storage device.

The method 600 further includes providing 610 the chipset firmware update data to the docking station without input from a host device of the docking station.

In some embodiments of the method 600, the chipset firmware update data is in an encrypted form.

In some embodiments of the method 600, the chipset firmware update data is in a signed form.

In some embodiments of the method 600, the network interface comprises a Wi-Fi interface.

In some embodiments of the method 600, the MCU performs the check on a periodic basis.

In some embodiments of the method 600, the MCU performs the check upon a connection of the USB storage device to the access point via the network interface.

In some embodiments of the method 600, the MCU performs the check upon a connection of the USB storage device to the docking station and prior to the USB storage device providing the firmware update data to the docking station.

The devices disclosed herein may respectively include one or more MCUs, SoCs, controllers, processors, etc. using instructions present thereon to implement one or more functionalities of each such device as those functionalities are described herein. The instructions used by such MCUs, SoCs, controllers, processors, etc. may be stored on a memory (e.g., a non-transitory computer readable storage medium) on, or in communication with, such MCUs, SoCs, controllers, processors, etc. It is anticipated that these MCUs, SoCs, controllers, processors, etc. (and/or any associated non-transitory computer-readable instructions for use thereon) may be present in any embodiment disclosed herein (even if not explicitly discussed).

This disclosure has been made with reference to various exemplary embodiments, including the best mode. However, those skilled in the art will recognize that changes and modifications may be made to the exemplary embodiments without departing from the scope of the present disclosure. While the principles of this disclosure have been shown in various embodiments, many modifications of structure, arrangements, proportions, elements, materials, and components may be adapted for a specific environment and/or operating requirements without departing from the principles and scope of this disclosure. These and other changes or modifications are intended to be included within the scope of the present disclosure.

This disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element. The scope of the present invention should, therefore, be determined by the following claims.

1. A docking station, comprising:
a microcontroller unit (MCU) comprising a validation engine;
a universal serial bus (USB) interface configured to facilitate communication between the MCU and a network interface system on a chip (SOC) communicatively coupled to the docking station; and
a chipset configured to operate chipset services with a host device communicatively coupled to the docking station, according to chipset firmware;
wherein the docking station is configured to:
receive, from the network interface SOC, chipset update binary for updating the chipset firmware for the chipset of the docking station, the chipset update binary including a signature;
determine, by the MCU, that the chipset update binary is signed;
validate, using the validation engine of the MCU, the chipset update binary based on validating the received signature without input from the host device; and
based on the validation, operate the MCU to update the chipset firmware using the chipset update binary data without input from the host device.

2. The docking station of claim 1, wherein the chipset update binary from the network interface SOC is received without input from the host device.

3. The docking station of claim 1, wherein the MCU further comprises a decryption engine configured to decrypt the chipset update binary, and wherein the chipset update binary is received from the network interface SOC and at the MCU in encrypted form.

4. The docking station of claim 3, wherein the MCU is further configured to decrypt the chipset update binary without input from the host device.

5. The docking station of claim 1, wherein the validation engine of the MCU is further configured to validate the signature of the chipset update binary without input from the host device.

6. The docking station of claim 1, wherein the network interface SOC is configured to receive the chipset update binary via a Wi-Fi access point using a Wi-Fi interface.

7. The docking station of claim 3, wherein the docking station is further configured to:
using the decryption engine of the MCU, determine the chipset update binary cannot be decrypted; and
based on said determination, discard the chipset update binary.

8. The docking station of claim 1, wherein updating the chipset firmware improves operation and performance of the chipset firmware, enables the chipset firmware to perform new services for the host device, enables the chipset firmware to operate a new host device, enables the chipset firmware to operate a new type of host device, or combinations thereof.

9. The docking station of claim 1, wherein the docking station is configured to operate the MCU to update the chipset firmware independent of the host device, such that the host device does not occupy the docking station during the update.

10. The docking station of claim 1, wherein the docking station is configured to operate the MCU to update the chipset firmware independent of the host device, minimizing logistics concerns of the host device, scheduling concerns of the host device, location concerns of the host device, worktime interruption concerns of the host device, or combinations thereof.

11. A method comprising:
receiving, from a network interface system on a chip (SOC) communicatively coupled to a docking station, chipset update binary for updating chipset firmware for a chipset of the docking station, the chipset update binary including a signature;
determining, by a microcontroller unit MCU of the docking station, that the chipset update binary is signed;
validating, using a validation engine of the MCU, the chipset update binary based on validating the received signature without input from a host device communicatively coupled to the docking station; and
based on the validation, updating, by the MCU, the chipset firmware using the chipset update binary data without input from the host device.

12. The method of claim 11, wherein the chipset update binary received from the network interface SOC is received without input from the host device.

13. The method of claim 11, the method further comprising:
decrypting, by a decryption engine of the MCU, the chipset update binary, wherein the chipset update binary is received from the network interface SOC and at the MCU in encrypted form.

14. The method of claim 13, wherein the decrypting, by the decryption engine of the MCU, of the chipset update binary is performed without input from the host device.

15. The method of claim 11, the method further comprising:
validating, by the validation engine of the MCU, the signature of the chipset update binary without input from the host device.

16. The method of claim 11, the method further comprising:
receiving, at the network interface SOC, the chipset update binary via a Wi-Fi access point using a Wi-Fi interface.

17. The method of claim 13, the method further comprising:
determining, using a decryption engine of the MCU, that the chipset update binary cannot be decrypted; and
based on said determining, discarding the chipset update binary.

18. The method of claim 11, wherein updating the chipset firmware improves operation and performance of the chipset firmware, enables the chipset firmware to perform new services for the host device, enables the chipset firmware to operate a new host device, enables the chipset firmware to operate a new type of host device, or combinations thereof.

19. The method of claim 11, wherein the docking station is configured to operate the MCU to update the chipset firmware independent of the host device, such that the host device does not occupy the docking station during the update.

20. The method of claim 11, wherein the docking station is configured to operate the MCU to update the chipset firmware independent of the host device, minimizing logistics concerns of the host device, scheduling concerns of the host device, location concerns of the host device, worktime interruption concerns of the host device, or combinations thereof.

21. A system comprising:
a network interface software on a chip (SOC) communicatively coupled to a network access point via a network interface; and
a docking station comprising:
a microcontroller unit (MCU) comprising a validation engine;
a universal serial bus (USB) interface configured to facilitate communication between the MCU and the network interface system SOC communicatively coupled to the docking station; and
a chipset configured to operate chipset services with a host device communicatively coupled to the docking station, according to chipset firmware; and
wherein the docking station is configured to:
receive, from the network interface SOC, chipset update binary for updating the chipset firmware for the chipset of the docking station, the chipset update binary including a signature;
determine that the chipset update binary is signed;
validate the chipset update binary based on validating the received signature without input from the host device; and
based on the validation, update the chipset firmware using the chipset update binary data without input from the host device.

22. The system of claim 21, wherein the chipset update binary from the network interface SOC is received without input from the host device.

23. The system of claim 21, wherein the MCU further comprises a decryption engine configured to decrypt the chipset update binary, and wherein the chipset update binary is received from the network interface SOC and at the MCU in encrypted form.

24. The system of claim 23, wherein the MCU is further configured to decrypt the chipset update binary without input from the host device.

25. The system of claim 21, wherein the network access point is a Wi-Fi access point, and wherein the network interface is a Wi-Fi interface.

26. The system of claim 21, wherein the network interface SOC is communicatively coupled to a server via the network access point, and wherein the server is a cloud server.

27. The system of claim 26, wherein the cloud server comprises the chipset update binary.

28. The system of claim 21, wherein the validation engine of the MCU is further configured to validate the signature of the chipset update binary without input from the host device.

29. The system of claim 21, wherein the network interface SOC is configured to receive the chipset update binary via the network access point using the network interface.

30. The system of claim 23, wherein the docking station is further configured to:
using the decryption engine of the MCU, determine the chipset update binary cannot be decrypted; and
based on said determination, discard the chipset update binary.

31. The system of claim 21, wherein updating the chipset firmware improves operation and performance of the chipset firmware, enables the chipset firmware to perform new services for the host device, enables the chipset firmware to operate a new host device, enables the chipset firmware to operate a new type of host device, or combinations thereof.

32. The system of claim 21, wherein the docking station is configured to operate the MCU to update the chipset firmware independent of the host device, such that the host device does not occupy the docking station during the update.

33. The system of claim 21, wherein the docking station is configured to operate the MCU to update the chipset firmware independent of the host device, minimizing logistics concerns of the host device, scheduling concerns of the host device, location concerns of the host device, worktime interruption concerns of the host device, or combinations thereof.

34. A docking station, comprising:
a microcontroller unit (MCU) comprising a validation engine;
a network interface system on a chip (SOC) in communication with a cloud server; and
a chipset configured to operate chipset services with a host device communicatively coupled to the docking station, according to chipset firmware;
wherein the docking station is configured to:
receive, from the cloud server and at the network interface SOC via Wi-Fi, chipset update binary for updating the chipset firmware for the chipset of the docking station, the chipset update binary including a signature;
determine, by the MCU, that the chipset update binary is signed;
validate, using the validation engine, the chipset update binary based on validating the received signature without input from the host device; and
based on the validation, update, by the MCU, the chipset firmware using the chipset update binary data without input from the host device.

35. The docking station of claim 34, wherein the chipset update binary from the network interface SOC is received without input from the host device.

36. The docking station of claim 34, wherein the MCU further comprises a decryption engine configured to decrypt the chipset update binary, and wherein the chipset update binary is received from the network interface SOC and at the MCU in encrypted form.

37. The docking station of claim 36, wherein the MCU is further configured to decrypt the chipset update binary without input from the host device.

38. The docking station of claim 34, wherein the validation engine of the MCU is further configured to validate the signature of the chipset update binary without input from the host device.

39. The docking station of claim 34, wherein the network interface SOC is configured to receive the chipset update binary, from the cloud server, via a Wi-Fi access point using a Wi-Fi interface.

40. The docking station of claim 36, wherein the docking station is further configured to:
using the decryption engine of the MCU, determine the chipset update binary cannot be decrypted; and
based on said determination, discard the chipset update binary.

41. The docking station of claim 34, wherein updating the chipset firmware improves operation and performance of the chipset firmware, enables the chipset firmware to perform new services for the host device, enables the chipset firmware to operate a new host device, enables the chipset firmware to operate a new type of host device, or combinations thereof.

42. The docking station of claim 34, wherein the docking station is configured to operate the MCU to update the chipset firmware independent of the host device, such that the host device does not occupy the docking station during the update.

43. The docking station of claim 34, wherein the docking station is configured to operate the MCU to update the chipset firmware independent of the host device, minimizing logistics concerns of the host device, scheduling concerns of the host device, location concerns of the host device, worktime interruption concerns of the host device, or combinations thereof.

44. A method comprising:
receiving, from a cloud server and at a network interface system on a chip (SOC) of a docking station via Wi-Fi, chipset update binary for updating chipset firmware for a chipset of the docking station, the chipset update binary including a signature;
determining, by a microcontroller unit (MCU) of the docking station, that the chipset update binary is signed;
validating, using a validation engine of the MCU, the chipset update binary based on validating the received signature without input from a host device communicatively coupled to the docking station; and
based on the validation, updating, by the MCU, the chipset firmware using the chipset update binary data without input from the host device.

45. The method of claim 44, wherein the chipset update binary received by the network interface SOC and from the cloud server is received without input from the host device.

46. The method of claim 44, the method further comprising:
decrypting, by a decryption engine of the MCU, the chipset update binary, wherein the chipset update binary is received from the network interface SOC and at the MCU in encrypted form.

47. The method of claim 46, wherein the decrypting, by the decryption engine of the MCU, of the chipset update binary is performed without input from the host device.

48. The method of claim 44, the method further comprising:
validating, by the validation engine of the MCU, the signature of the chipset update binary without input from the host device.

49. The method of claim 44, the method further comprising:
receiving, at the network interface SOC, the chipset update binary via a Wi-Fi access point using a Wi-Fi interface.

50. The method of claim 46, the method further comprising:
determining, using a decryption engine of the MCU, that the chipset update binary cannot be decrypted; and
based on said determining, discarding the chipset update binary.

51. The method of claim 44, wherein updating the chipset firmware improves operation and performance of the chipset firmware, enables the chipset firmware to perform new services for the host device, enables the chipset firmware to operate a new host device, enables the chipset firmware to operate a new type of host device, or combinations thereof.

52. The method of claim 44, wherein the docking station is configured to operate the MCU to update the chipset firmware independent of the host device, such that the host device does not occupy the docking station during the update.

53. The method of claim 44, wherein the docking station is configured to operate the MCU to update the chipset firmware independent of the host device, minimizing logistics concerns of the host device, scheduling concerns of the host device, location concerns of the host device, worktime interruption concerns of the host device, or combinations thereof.
